(19) United States
(12) Patent Application Publication
(10) Pub. No.: US 2021/0405440 A1
(43) Pub. Date: Dec. 30, 2021

(54) DISPLAY DEVICE, ELECTRONIC EQUIPMENT, AND MANUFACTURING METHOD OF DISPLAY DEVICE

(71) Applicant: WUHAN CHINA STAR OPTOELECTRONICS TECHNOLOGY CO., LTD., Wuhan Hubei (CN)

(72) Inventors: Pengfei YU, Wuhan, Hubei (CN); Chong LONG, Wuhan, Hubei (CN); Tao SONG, Wuhan, Hubei (CN); Wei TANG, Wuhan, Hubei (CN)

(21) Appl. No.: 16/632,469

(22) PCT Filed: Nov. 5, 2019
(86) PCT No.: PCT/CN2019/115829

§ 371 Date: Jan. 20, 2020

(30) Foreign Application Priority Data
Sep. 23, 2019 (CN) 201910899278.X

(51) Int. Cl. G02F 1/1335; H04M 1/02

(52) U.S. Cl. CPC G02F 1/133512; H04M 1/0266; G02F 1/133514; G02F 1/133528

(57) ABSTRACT

A display device of the present invention includes: a display panel having a light-transmitting region and a light-shielding region, and the light-shielding region disposed around the light-transmitting region; a polarizer disposed on the display panel, a first through-hole disposed on the polarizer, and the first through-hole disposed corresponding to the light-transmitting region; a backlight module disposed on the polarizer, a second through-hole disposed on the backlight module, and the second through-hole disposed corresponding to the light-transmitting region; and a light-shielding adhesive disposed around a wall of the second through-hole and extending to around a wall of the first through-hole.

### FIELD OF INVENTION

The present invention is related to the field of display technology, and specifically to a display device, an electronic equipment, and a manufacturing method of the display device.

### BACKGROUND OF INVENTION

With continuous development and improvement of display devices, display devices with higher screen-to-body ratio and more stunning display effects have gradually become mainstream. A current blind hole technology forms a light-transmitting region on a display panel through an opening in a screen, and devices such as a front camera are disposed under the screen to implement a full-screen effect. When the display panel and a backlight module are assembled, a region corresponding to an edge of the light-transmitting region needs to perform a double dispensing process of a light-shielding adhesive. Because of a dispensing accuracy problem and an overflow problem of a first dispensing process of the light-shielding adhesive, dispensing accuracy of the edge of the light-transmitting region is poor.

### SUMMARY OF INVENTION

The present invention provides a display device, an electronic equipment, and a manufacturing method of the display device to solve a technical problem that dispensing accuracy of an edge of the light-transmitting region is poor when the display panel and a backlight module are assembled.

The present invention provides a display device, including:

a display panel having a light-transmitting region and a light-shielding region, and the light-shielding region disposed around the light-transmitting region;

a polarizer disposed on the display panel, a first through-hole disposed on the polarizer, and the first through-hole disposed corresponding to the light-transmitting region;

a backlight module disposed on the polarizer, a second through-hole disposed on the backlight module, and the second through-hole disposed corresponding to the light-transmitting region; and

a light-shielding adhesive disposed around a wall of the second through-hole and extending to around a wall of the first through-hole.

In the display device of the present invention, the display panel includes an array substrate, a color film substrate, and a liquid crystal layer disposed between the array substrate and the color film substrate;

the array substrate includes a first base substrate and an array layer disposed on the first base substrate, and the color film substrate includes a second base substrate and a color film layer disposed on the second base substrate;

a first opening is disposed on the array substrate, and the first opening is disposed corresponding to the light-transmitting region; and

a second opening is disposed on the color film substrate, and the second opening is disposed corresponding to the light-transmitting region.

In the display device of the present invention, a light-shielding layer is disposed on a side of the first base substrate near the liquid crystal layer; and

in a thickness direction perpendicular to the display panel, an orthographic projection of the light-shielding layer on the display panel coincides with the light-shielding region.

In the display device of the present invention, in the thickness direction perpendicular to the display panel, the orthographic projection of the light-shielding layer on the display panel covers an orthographic projection of the light-shielding adhesive on the display panel.

In the display device of the present invention, a material of the light-shielding layer is metal.

In the display device of the present invention, a material of the light-shielding layer is metal.

In the display device of the present invention, a first insulating layer is disposed on a side of the light-shielding layer near the liquid crystal layer, and/or a second insulating layer is disposed on a side of the light-shielding layer away from the liquid crystal layer.

In the display device of the present invention, an alignment mark is disposed on the light-shielding region.

In the display device of the present invention, a hole diameter of the first through-hole and a hole diameter of the second through-hole are greater than a hole diameter of the light-transmitting region; and

the hole diameter of the first through-hole is greater than the hole diameter of the second through-hole.

The present invention further provides an electronic equipment including the display device described above, the display device including:

a display panel having a light-transmitting region and a light-shielding region, and the light-shielding region disposed around the light-transmitting region;

a polarizer disposed on the display panel, a first through-hole disposed on the polarizer, and the first through-hole disposed corresponding to the light-transmitting region;

a backlight module disposed on the polarizer, a second through-hole disposed on the backlight module, and the second through-hole disposed corresponding to the light-transmitting region; and

a light-shielding adhesive disposed around a wall of the second through-hole and extending to around a wall of the first through-hole.

In the electronic equipment of the present invention, the display panel includes an array substrate, a color film substrate, and a liquid crystal layer disposed between the array substrate and the color film substrate;

the array substrate includes a first base substrate and an array layer disposed on the first base substrate, and the color film substrate includes a second base substrate and a color film layer disposed on the second base substrate;

a first opening is disposed on the array substrate, and the first opening is disposed corresponding to the light-transmitting region; and

a second opening is disposed on the color film substrate, and the second opening is disposed corresponding to the light-transmitting region.

In the electronic equipment of the present invention, a light-shielding layer is disposed on a side of the first base substrate near the liquid crystal layer; and

in a thickness direction perpendicular to the display panel, an orthographic projection of the light-shielding layer on the display panel coincides with the light-shielding region.

In the electronic equipment of the present invention, in the thickness direction perpendicular to the display panel, the orthographic projection of the light-shielding layer on the display panel covers an orthographic projection of the light-shielding adhesive on the display panel.

In the electronic equipment of the present invention, a material of the light-shielding layer is metal.

In the electronic equipment of the present invention, a first insulating layer is disposed on a side of the light-shielding layer near the liquid crystal layer, and/or a second insulating layer is disposed on a side of the light-shielding layer away from the liquid crystal layer.

In the electronic equipment of the present invention, wherein an alignment mark is disposed on the light-shielding region.

In the electronic equipment of the present invention, a hole diameter of the first through-hole and a hole diameter of the second through-hole are greater than a hole diameter of the light-transmitting region.

The present invention further provides a manufacturing method of a display device, including:

providing a display panel, the display panel has a light-transmitting region and a light-shielding region, and the light-shielding region is disposed around the light-transmitting region;

providing a polarizer, the polarizer is disposed on the display panel, a first through-hole is disposed on the polarizer, and the first through-hole is disposed corresponding to the light-transmitting region;

providing a backlight module, the backlight module is disposed on the polarizer, a second through-hole is disposed on the backlight module, and the second through-hole is disposed corresponding to the light-transmitting region;

aligning and assembling the display panel, the polarizer, and the backlight module; and

forming a light-shielding adhesive by a single dispensing process, the light-shielding adhesive is disposed around a wall of the second through-hole and extends to around a wall of the first through-hole.

In the manufacturing method of a display device of the present invention, a light-shielding layer is disposed on a side of a base substrate near a liquid crystal layer.

In the manufacturing method of a display device of the present invention, an alignment mark is disposed on the light-shielding region.

Compared to a double dispensing process when assembling a display device in the prior art, the present invention disposes the light-shielding region around the light-transmitting region, which can prevent light from leaking. Meanwhile, the single dispensing process covers the wall of the first through-hole and the wall of the second through-hole to implement effective light-shielding and reduce a number of dispenses when assembling the display device, as well as increase dispensing accuracy of the edge of the light-transmitting region.

### DESCRIPTION OF DRAWINGS

In order to describe technical solutions in the present invention clearly, drawings to be used in the description of embodiments will be described briefly below. Obviously, drawings described below are only for some embodiments of the present invention, and other drawings may be obtained by those skilled in the art based on these drawings without creative efforts.

FIG. 1 is a structural diagram of an electronic equipment according to an embodiment of the present invention.

FIG. 2 is another structural diagram of the electronic equipment in FIG. 1 according to an embodiment of the present invention.

FIG. 3 is a structural diagram of a cross-sectional view XX′ in FIG. 2 according to an embodiment of the present invention.

FIG. 4 is another structural diagram of the cross-sectional view XX′ in FIG. 2 according to an embodiment of the present invention.

FIG. 5 is a plan diagram of a light-shielding region having an alignment mark according to an embodiment of the present invention.

FIG. 6 is a flowchart of a manufacturing method of a display device according to an embodiment of the present invention.

### DETAILED DESCRIPTION

To further explain the technical means and effect of the present invention, the following refers to embodiments and drawings for detailed description. Obviously, the described embodiments are only for some embodiments of the present invention, instead of all embodiments. All other embodiments based on embodiments in the present invention and obtained by those skilled in the art without creative efforts are within the scope of the present invention.

Examples are described below with reference to the appended drawings, and the drawings illustrate particular embodiments in which the present invention may be practiced. Directional terms mentioned in the present invention, such as upper, lower, front, rear, left, right, in, out, side, etc., only refer to directions in the accompanying drawings. Thus, the adoption of directional terms is used to describe and understand the present invention, but not to limit the present invention. In addition, the terms “first” and “second” are merely used for illustrative purposes only, but are not to be construed as indicating or imposing a relative importance or implicitly indicating the number of technical features indicated. Thus, a feature that defines “first” or “second” may expressly or implicitly include one or more of the features.

The present invention provides a display device, an electronic equipment, and a manufacturing method of the display device. The display device can be disposed in the electronic equipment, and the electronic equipment can be a smart phone, a tablet, etc.

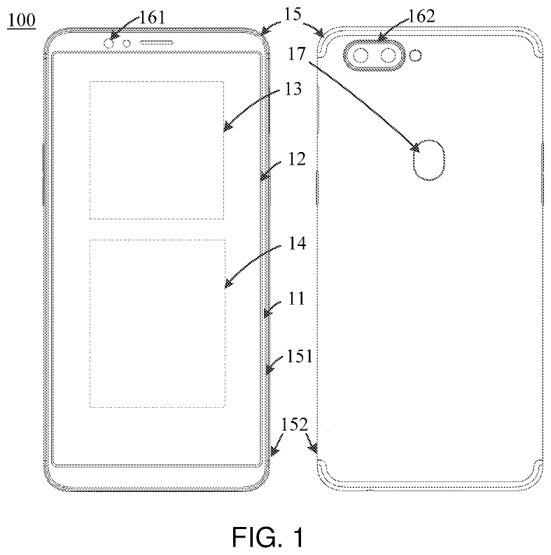

Please refer to FIG. 1, which is a structural diagram of an electronic equipment according to an embodiment of the present invention, the electronic equipment 100 can include a cover plate 11, a display device 12, a circuit board 13, a battery 14, a housing 15, a front camera 161, a rear camera 162, and a fingerprint unlock module 17. It should be noted that the electronic equipment 100 shown in FIG. 1 is not limited to the above content, and can also include other devices, or does not include the front camera 161, the rear camera 162, the fingerprint unlock module 17, etc.

The cover plate 11 is disposed on the display device 12 and covers the display device 12. The cover plate 11 can be a transparent glass cover plate to allow images of the display device 12 to pass through the cover plate 11. In some embodiments, the cover plate 11 can be a glass cover plate made of a material such as sapphire.

The housing 15 is formed into an outer profile of the electronic equipment 100. In some embodiments, the housing 15 can include a middle frame 151 and a back cover 152. The middle frame 151 and the back cover 152 are combined to form the housing 15. The middle frame 151 and the back cover 152 can form an accommodating space for accommodating devices such as the display device 12, the circuit board 13, and the battery 14. Furthermore, the cover plate 11 can be disposed on the housing 15. The cover plate 11 and the housing 15 form a closed space to accommodate devices such as the display device 12, the circuit board 13, and the battery 14. In some embodiments, the cover plate 11 is disposed on the middle frame 151, the back cover 152 is disposed on the middle frame 151, the cover plate 11 and the back cover 152 are located on opposite sides of the middle frame 151, and the cover plate 11 is disposed oppositely to the back cover 152.

In some embodiments, the housing 15 can be made of metal such as magnesium alloy, stainless steel, etc. It should be noted that a material of the housing 15 of this embodiment of the present invention is not limited herein, and other materials can be adopted. For example, the housing 15 can be a plastic housing, a ceramic housing, or a housing including a plastic part and a metal part. The housing 15 can also be a structure of a combination of plastic and metal. Specifically, the metal part can be formed first, for example, a magnesium alloy substrate is formed by injection molding, and a plastic substrate is formed on the magnesium alloy substrate to form a plastic substrate, thereby forming a complete housing. It should be noted that the materials of the housing 15 and manufacturing process thereof are not limited herein. For example, the housing 15 can also be a glass housing.

The circuit board 13 is installed in the housing 15. The circuit board 13 can be a motherboard of the electronic equipment 100. The circuit board 13 can be integrated with one, two, or more of a motor, a microphone, a speaker, a headphone jack, a universal serial bus interface, the front camera 161, the rear camera 162, a distance sensor, a ambient light sensor, a receiver, and a processor.

In some embodiments, the circuit board 13 can be fixed in the housing 15. Specifically, the circuit board can be screwed to the middle frame 151 by screws or can be clipped onto the middle frame 151 by clips. In this embodiment, it should be noted that a method of fixing the circuit board 13 on the middle frame 151 is not limited herein, and can be other methods such as using both clips and screws to fix the circuit board 13.

The battery 14 is installed in the housing 15. The battery 14 is electrically connected to the circuit board 13 to supply power to the electronic equipment 100. The housing 15 can be a battery cover of the battery 14. The housing 15 covers the battery 14 to protect the battery 14. Specifically, the back cover 152 covers the battery 14 to protect the battery 14 and prevent the battery 14 from damage caused by collision or drop of the electronic equipment 100.

The display device 12 is installed in the housing 15, meanwhile, the display device 12 is electrically connected to the circuit board 13 to form a display surface of the electronic equipment. The display device 12 can include a display region and a non-display region. The display region can be used to display images of the electronic equipment 100, or can be provided for a user to perform touch control. An opening for sound and light transmission is disposed on a top region of the non-display region. Functional modules such as a fingerprint module and a touch button can be disposed on a bottom region of the non-display region. The cover plate 11 is installed on the display device 12 and covers the display device 12, and can be formed into a display region and a non-display region having same size as the display device 12 or a display region and a non-display region having different sizes with the display device 12.

In some embodiments, the display device 12 can be a liquid crystal display (LCD). In some embodiments, the display device 12 can include an upper polarizer, a color film substrate, a liquid crystal layer, an array substrate, a lower polarizer, and a backlight module disposed in a stack.

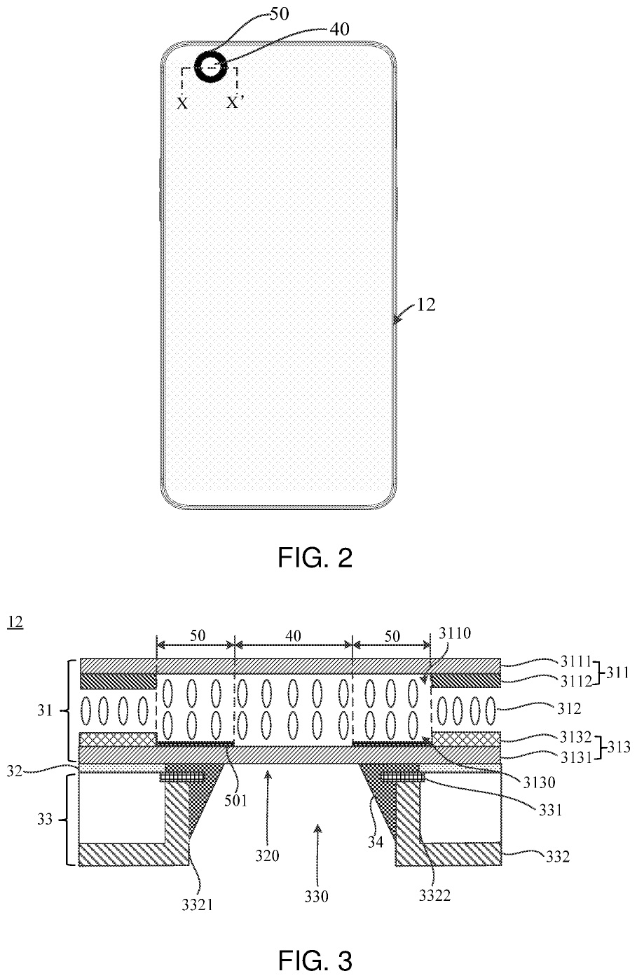

Please refer to FIG. 2, an electronic equipment in this embodiment of the present invention is based on the electronic equipment shown in FIG. 1, and a light-transmitting region 40 and a light-shielding region 50 are formed on the display device 12 directly. A through-hole passing through the backlight module in a thickness direction is disposed on the display device 12, and the through-hole is disposed corresponding to the light-transmitting region 40. A front camera or other light sensors can be disposed in a position of the through-hole.

Understandably, with continuous development of electronic equipment, electronic equipment with higher screen-to-body ratio and more stunning display effects have gradually become mainstream. A current blind hole technology forms a light-transmitting region on a display panel through an opening in a screen, and devices such as a front camera are disposed under the screen to implement a full-screen effect. However, in an actual production process, when a display device is assembled, a light-shielding adhesive dispensed by a double dispensing process is prone to an overflow problem and a problem that dispensing accuracy of an edge of the light-transmitting region is poor. In order to increase the dispensing accuracy of the edge of the light-transmitting region, the present invention disposes a light-shielding region on a display panel and dispenses the light-shielding adhesive by a single dispensing process to form a display device. The following takes a display device as an example for detailed description.

Please refer to FIG. 3, which is a structural diagram of a cross-sectional view XX′ in FIG. 2. The display device 12 includes a display panel 31, a polarizer 32, a backlight module 33, and a light-shielding adhesive 34. The display panel 31 has the light-transmitting region 40 and the light-shielding region 50. The polarizer 32 is disposed on the display panel 31 and has a first through-hole 320. The first through-hole 320 is disposed corresponding to the light-transmitting region 40. The backlight module 33 is disposed on the polarizer 32 and has a second through-hole 330. The second through-hole 330 is disposed corresponding to the light-transmitting region 40. The light-shielding adhesive 34 is disposed around a wall of the second through-hole 330 and extends to around a wall of the first through-hole 320. The display device 12 can be applied to the above electronic equipment.

The light-shielding region 50 is disposed around the light-transmitting region 40. External light passes through a part of the display panel 31 corresponding to the light-transmitting region 40, and external refers to outside of the electronic equipment. Internal light can be blocked by a part of the display panel 31 corresponding to the light-shielding region 50, for example, a leaking light generated by the polarizer 32 and the backlight module 33 can be blocked to prevent interference generated by external light passing through the light-transmitting region 40.

It should be noted that different light-shielding components can be disposed on the light-shielding region 50. The light-shielding component can be disposed on different structural layers or functional layers such as a first base substrate 3131 or a second base substrate 3111, and details are not described herein. The light-shielding component can be one or more of materials having a light-shielding effect such as ink, adhesive, and glue.

In a thickness direction perpendicular to the display panel 31, the polarizer 32 covers a side of the light-shielding region 50 near the first through-hole 320.

Understandably, the backlight module 33 includes a frame adhesive 331 and an iron frame 332. The frame adhesive 331 is disposed between the polarizer 32 and the iron frame 332 and sticks the backlight module 33 to the display panel 31. The iron frame 332 is opaque, which can effectively prevent the backlight module 33 from leaking light. The second through-hole 330 is defined by an outer side wall 3321 of the iron frame 332. Specifically, in the thickness direction perpendicular to the display panel 31, an inner side wall 3322 of the iron frame 332 is aligned with a wall of the first through-hole 320. The frame adhesive 331 is bonded to a side of the polarizer 32 near the first through-hole 320. The frame adhesive 331 protrudes from the outer side wall 3321.

The light-shielding adhesive 34 is disposed around a wall of the second through-hole 330 and extends to around a wall of the first through-hole 320. It should be noted that the light-shielding adhesive 34 further extends to a side of the first base substrate 3131 near the first through-hole 320 and covers a side of the frame adhesive 331 near the light-emitting region 40. The light-shielding adhesive 34 can further fix the display panel 31 and the backlight module 33 while achieving light-shielding. The light-shielding adhesive 34 includes but is not limited to ink, adhesive, glue, etc.

This embodiment of the present invention disposes the light-shielding region 50 around the light-transmitting region 40 and can prevent the display panel 31 from leaking light. The light-shielding adhesive 34 can effectively block the leaking light of the polarizer 32 and the backlight module 33. When the display device 12 is assembled, a number of dispenses is reduced, an overflow problem of a double dispensing process in the prior art is prevented, and dispensing accuracy of the edge of the light-transmitting region 40 is increased.

In some embodiments, the display panel 31 includes an array substrate 313, a color film substrate 311, and a liquid crystal layer 312 disposed between the array substrate 313 and the color film substrate 311. The array substrate 313 includes the first base substrate 3131 and an array layer 3132 disposed on the first base substrate 3131. The color film substrate 311 includes the second base substrate 3111 and a color film layer 3112 disposed on the second base substrate 3111. A first opening 3130 is disposed on the array substrate 313. The first opening 3130 is disposed corresponding to the light-transmitting region 40. A second opening 3110 is disposed on the color film substrate 311. The second opening 3110 is disposed corresponding to the light-transmitting region 40.

Specifically, in the thickness direction perpendicular to the display panel, an edge of the first opening 3130 and an edge of the second opening 3110 are both aligned with an edge of the light-shielding region 50 away from the light-transmitting region 40. In the light-transmitting region 40, the first opening 3130 passes through the array layer 3132, and the second opening 3110 passes through the color film layer 3112 to prevent the external light from being blocked when entering the light-transmitting region 40. In the light-shielding region 50, the first opening 3130 passes through the array layer 3132. The second opening 3110 only retains a black matrix (not shown), and the black matrix can shield light and improve the display effects of the display panel 31.

The first opening 3130 and the second opening 3110 are filled with liquid crystal.

On this basis, a light-shielding layer 501 is disposed on a side of the first base substrate 3131 near the liquid crystal layer 312. The light-shielding layer 501 is disposed around the light-transmitting region 40. In the thickness direction perpendicular to the display panel 31, an orthographic projection of the light-shielding layer 501 on the display panel 31 coincides with the light-shielding region 50. Accordingly, the light-shielding layer 501 can cover a side of the first base substrate 3131 near the first through-hole 320 and prevent the first base substrate 3131 from leaking light. It should be noted that a material of the light-shielding layer 501 includes but is not limited to ink, adhesive, glue, etc. A thickness of the light-shielding layer 501 depends on an actual circumstance.

Furthermore, in the thickness direction perpendicular to the display panel 31, the orthographic projection of the light-shielding layer 501 on the display panel 31 covers an orthographic projection of the light-shielding adhesive 34 on the display panel 31, which means that the light-shielding layer 501 can effectively cover the light-shielding adhesive 34. It should be noted that in the thickness direction perpendicular to the display panel 31, the light-shielding layer 501 covers a side of a frame adhesive 331 away from the light-transmitting region 40. Accordingly, the light-shielding layer 501 can completely cover a poor dispensing of overflow due to dispensing accuracy and interference of the frame adhesive, and further improve dispensing accuracy of the edge of the light-transmitting region 40.

In some embodiments, a material of the light-shielding layer 501 is metal. Because flatness of the light-shielding layer 501 formed of metal is better, a planar structure of a light-transmitting region 40 and a light-shielding 50 is finer.

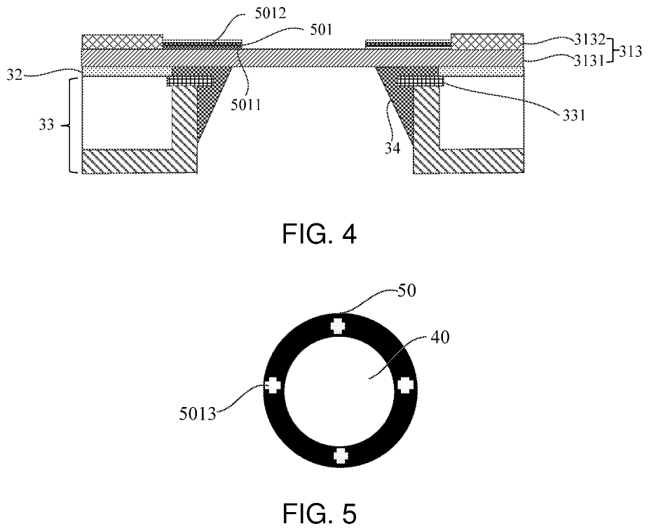

In some embodiments, a first insulating layer 5011 is disposed on a side of the light-shielding layer 501 near the liquid crystal layer 312, and/or a second insulating layer 5012 is disposed on a side of the light-shielding layer 501 away from the liquid crystal layer 312. Please refer to FIG. 4, this embodiment of the present invention takes metal as the material of the light-shielding layer 501 as an example for description. The first insulating layer 5011 is disposed on the first base substrate 3131. The light-shielding layer 501 is disposed on the first base substrate 3131. The second insulating layer 5012 is disposed on the light-shielding layer 501. The first insulating layer 5011 can increase adhesion of the light-shielding layer 501 to the first base substrate 3131. The second insulating layer 5012 can protect the light shielding layer 501.

In some embodiments, an alignment mark is disposed on a light-shielding region 50. The alignment mark can be disposed on different structures such as the array substrate 313 and the color film substrate 311 in the light-shielding region 50, which is not described herein. Please refer to FIG. 5, this embodiment of the present invention uses a light-shielding layer 501 disposed on a side of a first base substrate 3131 near a liquid crystal layer 312 as an example for description. Alignment marks 5013 are four identical cross-shaped patterns and are symmetrically disposed on an upper surface of the light-shielding layer 501. It should be noted that a shape, position, and a number of the alignment marks 5013 are not specifically limited in this embodiment of the present invention.

This embodiment of the present invention uses the alignment marks 5013 to effectively define the center position of a light-transmitting region 40 and uses a center alignment technology to align and assemble a display panel 31 and a backlight module 33, which is increases accuracy of an alignment assembly and product yield, and reduces a production cost.

In some embodiments, a first through-hole 320 is disposed coaxially with a light-transmitting region 40. A hole diameter of the first through-hole 320 is greater than a hole diameter of the light-transmitting region 40. A second through-hole 330 is disposed coaxially with the light-transmitting region 40. A hole diameter of the second through-hole 330 is greater than the hole diameter of the light-transmitting region 40. These structures can prevent external light passing the light-transmitting region 40 from being blocked.

On this basis, the hole diameter of the first through-hole 320 is greater than the hole diameter of the second through-hole 330. It should be noted that the hole diameter of the first through-hole 320 can be less than or equal to the hole diameter of the second through-hole 330. This embodiment of the present invention takes the hole diameter of the first through-hole 320 being greater than the hole diameter of the second through-hole 330 as an example. This structure can form a groove between a polarizer 32, the first base substrate 3131, and the backlight module 33. When a dispensing operation is performed, a light-shielding adhesive 34 extends to the groove, which increases a dispensing space of the light-shielding adhesive 34 and prevents the light-shielding adhesive 34 from extending to the light-transmitting region 40 and causing through-holes in the light-transmitting region 40 to be uneven.

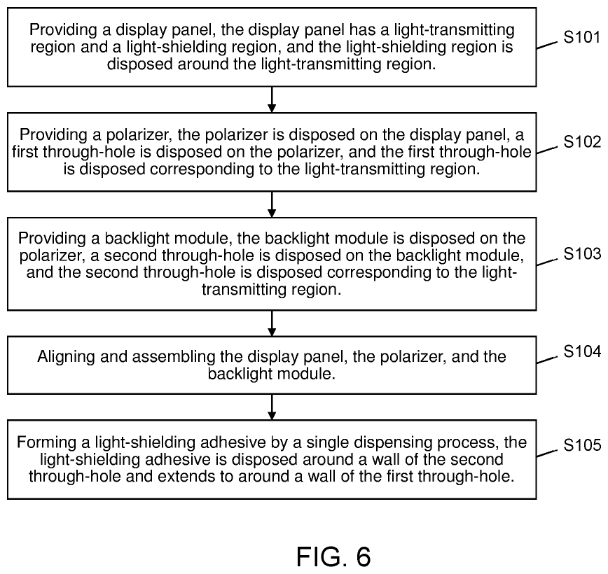

Please refer to FIG. 6, which is a flowchart of a manufacturing method of a display device according to an embodiment of the present invention. The manufacturing method of the display device includes:

S101, providing a display panel 31, the display panel 31 has a light-transmitting region 40 and a light-shielding region 50, and the light-shielding region 50 is disposed around the light-transmitting region 40.

S102, providing a polarizer 32, the polarizer 32 is disposed on the display panel 31, a first through-hole 320 is disposed on the polarizer 32, and the first through-hole 320 is disposed corresponding to the light-transmitting region 40.

S103, providing a backlight module 33, the backlight module 33 is disposed on the polarizer 32, a second through-hole 330 is disposed on the backlight module 33, and the second through-hole 330 is disposed corresponding to the light-transmitting region 40.

S104, aligning and assembling the display panel 31, the polarizer 32, and the backlight module 33.

S105, forming a light-shielding adhesive 34 by a single dispensing process, the light-shielding adhesive 34 is disposed around a wall of the second through-hole 330 and extends to around a wall of the first through-hole 320.

In the steps of the manufacturing method of the display device according to an embodiment of the present invention, related descriptions of the display panel 31, the polarizer 32, the backlight module 33, and the light-shielding adhesive 34 can be referred to above contents, and details are not described herein again.

Thus, compared to a double dispensing process when assembling a display device in the prior art, the present invention disposes the light-shielding region around the light-transmitting region, which can prevent the display panel from leaking light. Meanwhile, the single dispensing process covers the wall of the first through-hole and the wall of the second through-hole to prevent the polarizer and the backlight module from leaking light and further fixes the display panel and the backlight module. This manufacturing method reduces a number of dispenses when assembling the display device and prevents an overflow problem of a double dispensing process in the prior art, as well as increases dispensing accuracy of an edge of the light-transmitting region.

In some embodiments, as shown in FIG. 3, the light-shielding layer 501 is disposed on a side of the first base substrate 3131 near the liquid crystal layer 312. The light-shielding layer 501 can be formed by different processes such as dispensing, inkjet printing, or coating. The thickness of the light-shielding layer 501 depends on an actual operation. The material of the light-shielding layer 501 includes but is not limited to ink, adhesive, and glue.

In some embodiments, the material of the light-shielding layer 501 can be metal.

On this basis, the first insulating layer 5011 is disposed on the side of the light-shielding layer 501 near the liquid crystal layer 312, and/or the second insulating layer 5012 is disposed on the side of the light-shielding layer 501 away from the liquid crystal layer 312. The first insulating layer 5011 and the second insulating layer 5011 can be formed by different processes such as dispensing, inkjet printing, or coating.

In some embodiments, the light-shielding layer 501, the first insulating layer 5011, and the second insulating layer 5012 can be included in functional layers of the array layer 3132. Specifically, when the array substrate is manufactured, the first insulating layer 5011 is coated on an upper surface of the first base substrate 3131 first. Then, a gate layer (light-shielding layer 501) is formed on the first insulating layer 5011, and the second insulating layer is coated on the gate layer. Finally, other functional layers of the array substrate are manufactured. In this embodiment of the present invention, when the array layer 3132 located on the light-transmitting region 40 and the light-shielding region 50 is removed, the first insulating layer 5011, the gate layer, and the second insulating layer 5012 on the light-shielding region 50 are retained, thereby manufacturing process and production costs are reduced.

In some embodiments, alignment marks are disposed on the light-shielding region 50. Please refer to FIG. 5, this embodiment of the present invention uses different processes such as coating or etching to dispose different alignment marks 5013 on the light-shielding layer 501. The shape, position, and number of the alignment marks 5013 are not specifically limited in this embodiment of the present invention.

Furthermore, this embodiment of the present invention uses the center alignment technology to align and assemble the display panel 31 and the backlight module 33. The alignment marks 5013 disposed on the light-shielding region 50 can define the center position of the light-transmitting region 40 and align a center of the second through-hole 330, which increases accuracy of the alignment assembly of the display panel 31 and the backlight module, increases product yield, and reduces a production cost.

The embodiments of the present invention have been described in detail above, and the principles and implementations of the present invention are set forth herein by applying specific examples, and the description of the above embodiments is merely used to help to understand the method and core idea of the present invention. Meanwhile, for a person of ordinary skill in the art, according to the concept of the present invention, changes will be made to the specific implementations and application ranges, and in summary, the contents of the present description should not be construed as limiting the present invention.

What is claimed is:

1. A display device, comprising:
a display panel having a light-transmitting region and a light-shielding region, and the light-shielding region disposed around the light-transmitting region;
a polarizer disposed on the display panel, a first through-hole disposed on the polarizer, and the first through-hole disposed corresponding to the light-transmitting region;
a backlight module disposed on the polarizer, a second through-hole disposed on the backlight module, and the second through-hole disposed corresponding to the light-transmitting region; and
a light-shielding adhesive disposed around a wall of the second through-hole and extending to around a wall of the first through-hole.

2. The display device as claimed in claim 1, wherein the display panel comprises an array substrate, a color film substrate, and a liquid crystal layer disposed between the array substrate and the color film substrate;
the array substrate comprises a first base substrate and an array layer disposed on the first base substrate, and the color film substrate comprises a second base substrate and a color film layer disposed on the second base substrate;
a first opening is disposed on the array substrate, and the first opening is disposed corresponding to the light-transmitting region; and
a second opening is disposed on the color film substrate, and the second opening is disposed corresponding to the light-transmitting region.

3. The display device as claimed in claim 2, wherein a light-shielding layer is disposed on a side of the first base substrate near the liquid crystal layer; and
in a thickness direction perpendicular to the display panel, an orthographic projection of the light-shielding layer on the display panel coincides with the light-shielding region.

4. The display device as claimed in claim 3, wherein in the thickness direction perpendicular to the display panel, the orthographic projection of the light-shielding layer on the display panel covers an orthographic projection of the light-shielding adhesive on the display panel.

5. The display device as claimed in claim 3, wherein a material of the light-shielding layer is metal.

6. The display device as claimed in claim 4, wherein a material of the light-shielding layer is metal.

7. The display device as claimed in claim 5, wherein a first insulating layer is disposed on a side of the light-shielding layer near the liquid crystal layer, and/or a second insulating layer is disposed on a side of the light-shielding layer away from the liquid crystal layer.

8. The display device as claimed in claim 1, wherein an alignment mark is disposed on the light-shielding region.

9. The display device as claimed in claim 1, wherein a hole diameter of the first through-hole and a hole diameter of the second through-hole are greater than a hole diameter of the light-transmitting region; and
the hole diameter of the first through-hole is greater than the hole diameter of the second through-hole.

10. An electronic equipment comprising a display device, the display device comprising:
a display panel having a light-transmitting region and a light-shielding region, and the light-shielding region disposed around the light-transmitting region;
a polarizer disposed on the display panel, a first through-hole disposed on the polarizer, and the first through-hole disposed corresponding to the light-transmitting region;
a backlight module disposed on the polarizer, a second through-hole disposed on the backlight module, and the second through-hole disposed corresponding to the light-transmitting region; and
a light-shielding adhesive disposed around a wall of the second through-hole and extending to around a wall of the first through-hole.

11. The electronic equipment as claimed in claim 10, wherein the display panel comprises an array substrate, a color film substrate, and a liquid crystal layer disposed between the array substrate and the color film substrate;
the array substrate comprises a first base substrate and an array layer disposed on the first base substrate, and the color film substrate comprises a second base substrate and a color film layer disposed on the second base substrate;
a first opening is disposed on the array substrate, and the first opening is disposed corresponding to the light-transmitting region; and
a second opening is disposed on the color film substrate, and the second opening is disposed corresponding to the light-transmitting region.

12. The electronic equipment as claimed in claim 11, wherein a light-shielding layer is disposed on a side of the first base substrate near the liquid crystal layer; and
in a thickness direction perpendicular to the display panel, an orthographic projection of the light-shielding layer on the display panel coincides with the light-shielding region.

13. The electronic equipment as claimed in claim 12, wherein in the thickness direction perpendicular to the display panel, the orthographic projection of the light-shielding layer on the display panel covers an orthographic projection of the light-shielding adhesive on the display panel.

14. The electronic equipment as claimed in claim 12, wherein a material of the light-shielding layer is metal.

15. The electronic equipment as claimed in claim 14, wherein a first insulating layer is disposed on a side of the light-shielding layer near the liquid crystal layer, and/or a second insulating layer is disposed on a side of the light-shielding layer away from the liquid crystal layer.

16. The electronic equipment as claimed in claim 10, wherein an alignment mark is disposed on the light-shielding region.

17. The electronic equipment as claimed in claim 10, wherein a hole diameter of the first through-hole and a hole diameter of the second through-hole are greater than a hole diameter of the light-transmitting region.

18. A manufacturing method of a display device, comprising:
providing a display panel, the display panel has a light-transmitting region and a light-shielding region, and the light-shielding region is disposed around the light-transmitting region;
providing a polarizer, the polarizer is disposed on the display panel, a first through-hole is disposed on the polarizer, and the first through-hole is disposed corresponding to the light-transmitting region;
providing a backlight module, the backlight module is disposed on the polarizer, a second through-hole is disposed on the backlight module, and the second through-hole is disposed corresponding to the light-transmitting region;
aligning and assembling the display panel, the polarizer, and the backlight module; and
forming a light-shielding adhesive by a single dispensing process, the light-shielding adhesive is disposed around a wall of the second through-hole and extends to around a wall of the first through-hole.

19. The manufacturing method of the display device as claimed in claim 18, wherein a light-shielding layer is disposed on a side of a base substrate near a liquid crystal layer.

20. The manufacturing method of the display device as claimed in claim 18, wherein an alignment mark is disposed on the light-shielding region.
